(19) United States
(12) Patent Application Publication
(10) Pub. No.: US 2015/0377390 A1
(43) Pub. Date: Dec. 31, 2015

(54) PIPING COMPONENT AND PIPE

(71) Applicant: KABUSHIKI KAISHA TOSHIBA, Tokyo (JP)

(72) Inventor: Yoshihisa OOSAKI, Yokkaichi Mie (JP)

(73) Assignee: KABUSHIKI KAISHA TOSHIBA, Tokyo (JP)

(21) Appl. No.: 14/481,729

(22) Filed: Sep. 9, 2014

Related U.S. Application Data
(60) Provisional application No. 62/017,672, filed on Jun. 26, 2014.

(51) Int. Cl. F16L 13/10

(52) U.S. Cl. CPC F16L 13/103

(57) ABSTRACT

A piping component according to an embodiment includes a first joint member and a second joint member. The first joint member has a first covering portion. The first covering portion covers one of end portions of a bonding unit between the first joint member and a first piping unit, located in an insertion direction of the first piping unit, from a side of a hollow of the first joint member. The second joint member has a second covering portion. The second covering portion covers one of end portions of a bonding unit between the second joint member and a second piping unit, located in an insertion direction of the second piping unit, from a side of a hollow of the second joint member.

### CROSS REFERENCE TO RELATED APPLICATIONS

This application is based upon and claims the benefit of priority from the prior U.S. Provisional Patent Application No. 62/017,672 filed on Jun. 26, 2014, the entire contents of which are incorporated herein by reference.

### FIELD

Embodiments described herein relate generally to a piping component and a pipe.

### BACKGROUND

In a semiconductor manufacturing device, a pipe is conventionally used to drain a chemical liquid having been used in manufacturing of semiconductors from the semiconductor manufacturing device. A pipe connection structure such as a union connection structure is used as a pipe for chemical liquid drainage. In the union connection structure, a tube on a chemical-liquid inflow side and a tube on a chemical-liquid outflow side are generally inserted to a union joint unit and adhered thereto.

However, in the conventional union connection structure, the chemical liquid is likely to permeate connection portions between the tubes and the union joint unit (hereinafter, also “tube connection portions”) when the pipe is installed vertically. Furthermore, in the conventional union connection structure, there is a risk of leakages of the chemical liquid from the tube connection portions due to a decrease in adhesion performances of the tubes caused by connection failures or aging of the tube connection portions, or the like. Such a risk occurs also in a case where the pipe is inverted upside down.

Therefore, a structure that enables to avoid leakages from the tube connection portions is required.

### BRIEF DESCRIPTION OF THE DRAWINGS

FIG. 1 is a cross-sectional view showing an example of a configuration of a pipe 1 according to a first embodiment;

FIG. 2 is a partial enlarged view of the second joint member 14 in the pipe 1 shown in FIG. 1;

FIG. 3 is a cross-sectional view showing an example of a configuration of the pipe 1 according a second embodiment; and

FIG. 4 is a cross-sectional view showing an example of a configuration of the pipe 1 according to a third embodiment.

### DETAILED DESCRIPTION

Embodiments will now be explained with reference to the accompanying drawings. The present invention is not limited to the embodiments.

A piping component according to an embodiment comprises a first joint member and a second joint member. The first joint member has a first piping unit inserted thereto and is bonded to the first piping unit. The second joint member is connected to the first joint member, has a second piping unit inserted to the second joint member, and is bonded to the second piping unit. The first joint member has a first covering portion. The first covering portion covers one of end portions of a bonding unit between the first joint member and the first piping unit, located in an insertion direction of the first piping unit, from a side of a hollow of the first joint member. The second joint member has a second covering portion. The second covering portion covers one of end portions of a bonding unit between the second joint member and the second piping unit, located in an insertion direction of the second piping unit, from a side of a hollow of the second joint member.

### First Embodiment

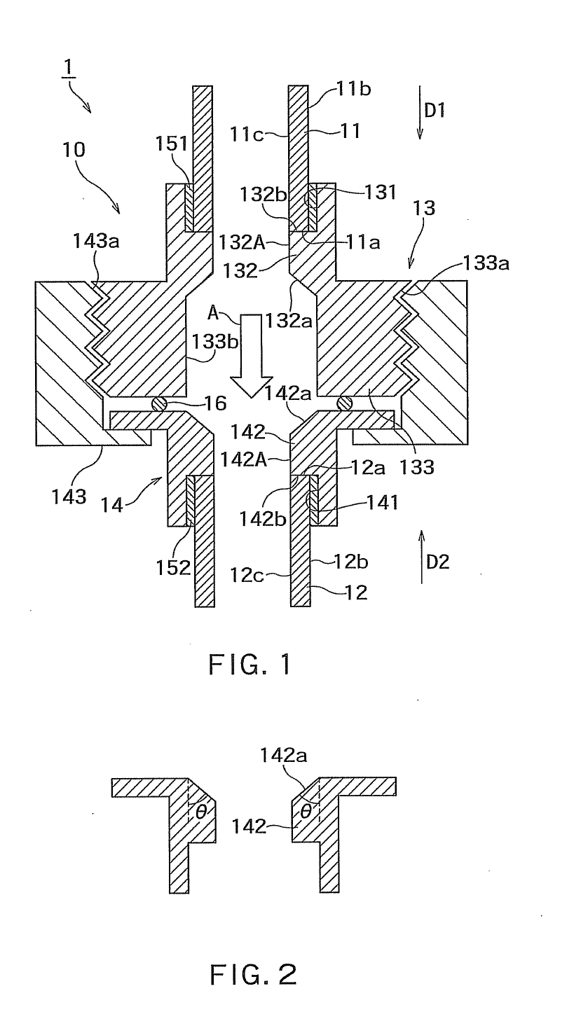

FIG. 1 is a cross-sectional view showing an example of a configuration of a pipe 1 according to a first embodiment. The pipe 1 includes a pipe joint 10, a first piping unit 11, a second piping unit 12, a first adhesion unit 151, and a second adhesion unit 152 as piping components. The pipe joint 10 includes a first joint member 13, a second joint member 14, and a seal ring 16.

The first piping unit 11 is formed of a resin material such as a polyvinyl chloride into a cylindrical shape. An upstream end of the first piping unit 11 is connected to a semiconductor manufacturing device (not shown). A chemical liquid having been used for manufacturing of semiconductors flows from the semiconductor manufacturing device into the first piping unit 11. The chemical liquid having flowed in the first piping unit 11 flows inside the first piping unit 11 toward a downstream end (a lower end in FIG. 1) of the first piping unit 11.

A part of the first piping unit 11 on the side of a downstream end is adhered to the first joint member 13 of the pipe joint 10 by the first adhesion unit 151. The first joint member 13 is formed of a resin material such as a polyvinyl chloride.

The first adhesion unit 151 is an example of a bonding unit that bonds the first joint member 13 and the first pining unit 11 with each other. The first adhesion unit 151 is a cured adhesive. The adhesive constituting the first adhesion unit 151 is preferably an adhesive that is suitable for materials of the first piping unit 11 and the first joint member 13 as adhesion targets and that has a chemical resistance to the chemical liquid. The adhesive constituting the first adhesion unit 151 is, for example, a vinyl chloride-based adhesive.

The second piping unit 12 is formed of a resin material such as a polyvinyl chloride into a cylindrical shape. A part of the second piping unit 12 on the side of an upstream end (an upper end in FIG. 1) is adhered to the second joint member 14 of the pipe joint 10 by the second adhesion unit 152. The second joint member 14 is formed of a resin material such as a polyvinyl chloride.

The chemical liquid having passed inside the pipe joint 10 flows in the second piping unit 12 from the side of the first piping unit 11. A flow of the chemical liquid inside the pipe joint 10 will be explained later. The chemical liquid having flowed in the second piping unit 12 flows inside the second piping unit 12 toward a downstream end of the second piping unit 12. The downstream end of the second piping unit 12 is connected to another piping unit, a chemical-liquid recovery device, a chemical-liquid processing device, or the like.

The second adhesion unit 152 is an example of a bonding unit that bonds the second joint member 14 and the second piping unit 12 with each other. The second adhesion unit 152 is a cured adhesive. The adhesive constituting the second adhesion unit 152 is preferably an adhesive that is suitable for materials of the second piping unit 12 and the second joint member 14 as adhesion targets and that has a chemical resistance to the chemical liquid. The adhesive constituting the second adhesion unit 152 is, for example, a vinyl chloride-based adhesive.

In this way, the first piping unit 11 and the second piping unit 12 are adhered to the pipe joint 10, thereby being connected to each other via the pipe joint 10.

### First Joint Member 13

The first joint member 13 is formed hollowly to allow the chemical liquid to flow therethrough. The first joint member 13 is adhered to the first piping unit 11 at an upper portion thereof and is connected to the second joint member 14 at a lower portion thereof.

Specifically, the first joint member 13 has a first adhesion surface 131 serving as a first bonding surface at an upper end portion thereof. The first adhesion surface 131 is adhered to the first piping unit 11 by the first adhesion unit 151 in a state of surrounding an outer circumferential surface 11b of the first piping unit 11. That is, the first piping unit 11 is bonded to the first adhesion surface 131 in a state of being inserted in the first joint member 13.

While the first adhesion surface 131 shown in FIG. 1 is a cylindrical surface, the shape of the first adhesion surface 131 can be changed according to the shape of the outer circumferential surface 11b of the first piping unit 11. For example, when the outer circumferential surface 11b of the first piping unit 11 is a square tube surface, the first adhesion surface 131 can be correspondingly formed in a square tube surface.

As described above, an adhesive having a chemical resistance can be selected as the adhesive constituting the first adhesion unit 151. However, even when an adhesive having a chemical resistance is selected, a continuous exposure thereof to a strongly-acidic or strongly-alkaline chemical liquid causes an adhesion failure or aging of the adhesive. Accordingly, the chemical liquid flowing through the hollow of the first joint member 13 may leak to outside from the first adhesion unit 151.

In terms of suppressing such a leakage of the chemical liquid from the first adhesion unit 151, the first joint member 13 has a first covering portion 132. The first covering portion 132 is formed at a lower end portion of the first adhesion surface 131 all around the lower end portion. The lower end portion of the first adhesion surface 131 is an example of an end portion of the first adhesion surface 131 on a side in an insertion direction D1 of the first piping unit 11.

The first covering portion 132 protrudes to inside the first joint member 13, that is, to the side of the hollow relative to the first adhesion surface 131 to cover a lower end portion of the first adhesion unit 151 from the side of the hollow of the first joint member 13. The direction of protrusion of the first covering portion 132 is substantially orthogonal to the insertion direction D1 of the first piping unit 11.

The first covering portion 132 protrudes to an inner side than the outer circumferential surface 11b of the first piping unit 11 to cover the lower end portion of the first adhesion unit 151. To cover the lower end portion of the first adhesion unit 151, it suffices that the first covering portion 132 protrudes to an inner side than the outer circumferential surface 11b of the first piping unit 11 at least on an end face 132b thereof on the side of the first piping unit 11.

While the first covering portion 132 protrudes up to the position of an inner circumferential surface 11c of the first piping unit 11, it is preferable that the first covering portion 132 does not protrude to an inner side than the inner circumferential surface 11c of the first piping unit 11 to ensure the capacity of the hollow of the first joint member 13 and to suppress a pipe resistance. As described above, the first covering portion 132 can protrude to a position inner than the outer circumferential surface 11b of the first piping unit 11 and outer than the inner circumferential surface 11c of the first piping unit 11. That is, the first covering portion 132 can protrude to a position between the inner circumferential surface 11c and the outer circumferential surface 11b of the first piping unit 11.

With the first covering portion 132 described above, the lower end portion of the first adhesion unit 151 is covered from the side of the hollow of the first joint member 13. Accordingly, the chemical liquid flowing through the hollow of the first joint member 13 comes in contact little with the first adhesion unit 151 and a leakage of the chemical liquid to outside from between the first joint member 13 and the first piping unit 11 can be suppressed.

By preventing the first covering portion 132 from protruding excessively, the capacity of the hollow of the first joint member 13 is ensured and the pipe resistance can be suppressed. Accordingly, the chemical liquid can be flowed smoothly through the hollow of the first joint member 13.

Furthermore, a first inclined surface 132a is formed on an inner circumferential surface 132A of the first covering portion 132. The first inclined surface 132a inclines to an outer side of the first joint member 13 toward the insertion direction D1 of the first piping unit 11. The first inclined surface 132a is formed on the inner circumferential surface 132A of the first covering portion 132 all therearound. The first inclined surface 132a can suppress the pipe resistance when the chemical liquid is flowed from the side of the second joint member 14 to the side of the first joint member 13. Accordingly, the first joint member 13 can flow the chemical liquid more smoothly through the hollow.

While the first inclined surface 132a shown in FIG. 1 is a conical surface, that is, an inversely tapered surface, the shape of the first inclined surface 132a can be changed according to the shape of the first adhesion surface 131. For example, when the first adhesion surface 131 is a square tube surface, the first inclined surface 132a can be correspondingly formed in a pyramid surface.

The end face 132b of the first covering portion 132 on the side of the first piping unit 11 and an end face 11a of the first piping unit 11 on the side of the first covering portion 132 are parallel to each other. Accordingly, when the first piping unit 11 is to be adhered to the first joint member 13, positioning of the first piping unit 11 can be easily achieved by causing the end face 11a of the first piping unit 11 to abut on the end face 132b of the first joint member 13.

A lower portion of the first joint member 13 has a first flange 133 that is extended to an outer side than an upper portion of the first joint member 13. A first thread groove 133a is formed on an outer circumferential surface of the first flange 133. The first joint member 13 thereby functions as an external thread to be fastened to the second joint member 14.

An inner circumferential surface 133b that extends from a lower end of the first inclined surface 132a to a lower end of the first joint member 13 is formed on an internal side of the first flange 133, and the inside of the inner circumferential surface 133b is a passage of the chemical liquid.

### Second Joint Member 14

The second joint member 14 is formed hollowly to allow the chemical liquid to flow therethrough. The second joint member 14 is connected to the first joint member 13 at an upper portion thereof and is adhered to the second piping unit 12 at a lower portion thereof.

Specifically, the second joint member 14 has a second adhesion surface 141 at a lower end portion thereof. The second adhesion surface 141 is adhered to the second piping unit 12 by the second adhesion unit 152 in a state of surrounding an outer circumferential surface 12b of the second piping unit 12. That is, the second piping unit 12 is bonded to the second adhesion surface 141 in a state of being inserted in the second joint member 14.

While the second adhesion surface 141 shown in FIG. 1 is a cylindrical surface, the shape of the second adhesion surface 141 can be changed according to the shape of the outer circumferential surface 12b of the second piping unit 12. For example, when the outer circumferential surface 12b of the second piping unit 12 is a square tube surface, the second adhesion surface 141 can be correspondingly formed in a square tube surface.

As described above, an adhesive having a chemical resistance can be selected as the adhesive constituting the second adhesion unit 152. However, even when an adhesive having a chemical resistance is selected, a continuous exposure thereof to the chemical liquid may cause a leakage of the chemical liquid flowing through the hollow of the second joint member 14 to outside from the second adhesion unit 152 as described above.

In terms of suppressing such a leakage of the chemical liquid from the second adhesion unit 152, the second joint member 14 has a second covering portion 142. The second covering portion 142 is formed at an upper end portion of the second adhesion surface 141 all around the upper end portion. The upper end portion of the second adhesion surface 141 is an example of an end portion of the second adhesion surface 141 on a side in an insertion direction D2 of the second piping unit 12. In the first embodiment, the insertion direction D2 of the second piping unit 12 is opposite to the insertion direction D1 of the first piping unit 11.

The second covering portion 142 protrudes to inside the second joint member 14, that is, to the side of the hollow relative to the second adhesion surface 141 to cover an upper end portion of the second adhesion unit 152 from the side of the hollow of the second joint member 14. The direction of protrusion of the second covering portion 142 is substantially orthogonal to the insertion direction D2 of the second piping unit 12.

The second covering portion 142 protrudes to an inner side than the outer circumferential surface 12b of the second piping unit 12 to cover the upper end portion of the second adhesion unit 152. To cover the upper end portion of the second adhesion unit 152, it suffices that the second covering portion 142 protrudes to an inner side than the outer circumferential surface 12b of the second piping unit 12 at least on an end face 142b thereof on the side of the second piping unit 12.

While the second covering portion 142 protrudes up to the position of an inner circumferential surface 12c of the second piping unit 12, it is preferable that the second covering portion 142 does not protrude to an inner side than the inner circumferential surface 12c of the second piping unit 12 to ensure the capacity of the hollow of the second joint member 14 and to suppress a pipe resistance. As described above, the second covering portion 142 can protrude to a position inner than the outer circumferential surface 12b of the second piping unit 12 and outer than the inner circumferential surface 12c of the second piping unit 12. That is, the second covering portion 142 can protrude to a position between the inner circumferential surface 12c and the outer circumferential surface 12b of the second piping unit 12.

With the second covering portion 142 described above, the upper end portion of the second adhesion unit 152 is covered from the side of the hollow of the second joint member 14. Accordingly, the chemical liquid flowing through the hollow of the second joint member 14 comes in contact little with the second adhesion unit 152 and a leakage of the chemical liquid to outside from between the second joint member 14 and the second piping unit 12 can be suppressed.

By preventing the second covering portion 142 from protruding excessively, the capacity of the hollow of the second joint member 14 is ensured and the pipe resistance can be suppressed. Accordingly, the chemical liquid can be flowed smoothly through the hollow of the second joint member 14.

Furthermore, a second inclined surface 142a is formed on an inner circumferential surface 142A of the second covering portion 142. The second inclined surface 142a inclines to an outer side of the second joint member 14 toward the insertion direction D2 of the second piping unit 12. The second inclined surface 142a is formed on the inner circumferential surface 142A of the second covering portion 142 all therearound.

The second inclined surface 142a can suppress the pipe resistance when the chemical liquid is flowed from the side of the first joint member 13 to the side of the second joint member 14 as shown by an arrow A in FIG. 1. Accordingly, the second joint member 14 can flow the chemical liquid more smoothly through the hollow.

While the second inclined surface 142a shown in FIG. 1 is a conical surface, that is, an inversely tapered surface, the shape of the second inclined surface 142a can be changed according to the shape of the second adhesion surface 141. For example, when the second adhesion surface 141 is a square tube surface, the second inclined surface 142a can be correspondingly formed in a pyramid surface.

The end face 142b of the second covering portion 142 on the side of the second piping unit 12 and an end face 12a of the second piping unit 12 on the side of the second covering portion 142 are parallel to each other. Accordingly, when the second piping unit 12 is to be adhered to the second joint member 14, positioning of the second piping unit 12 can be easily achieved by causing the end face 12a of the second piping unit 12 to abut on the end face 142b of the second joint member 14.

An upper portion of the second joint member 14 has a second flange 143 that is extended to an outer side than a lower portion of the second joint member 14. A second thread groove 143a is formed on an inner circumferential surface of the second flange 143. The second thread groove 143a engages with the first thread groove 133a formed on the first joint member 13. The second joint member 14 thereby functions as an internal thread to be fastened to the first joint member 13. This enables the second joint member 14 and the first joint member 13 to be removably connected to each other.

FIG. 2 is a partial enlarged view of the second joint member 14 in the pipe 1 shown in FIG. 1. An inclination angle of the second inclined surface 142a is set to a value appropriate for suppressing the pipe resistance to the chemical liquid flowing through the pipe 1. For example, as shown in FIG. 2, the inclination angle θ of the second inclined surface 142a is preferably larger than 0° C. and smaller than 90° C.

Also as for the first inclined surface 132a, an appropriate inclination angle in consideration of the pipe resistance can be set similarly to the second inclined surface 142a. The inclination angle of the first inclined surface 132a can be the same as that of the second inclined surface 142a. Accordingly, even when the direction of flowing the chemical liquid is reversed or even when the pipe joint 10 is inverted upside down, an effect of suppressing the pipe resistance can be achieved as explained later.

### Seal Ring 16

The seal ring 16 is located between the first joint member 13 and the second joint member 14. Specifically, the seal ring 16 is sandwiched between an end face of the first joint member 13 on the side of the second joint member 14 and an end face of the second joint member 14 on the side of the first joint member 13. This enables a connection portion between the first joint member 13 and the second joint member 14 to be sealed airtightly. The material of the seal ring 16 is not particularly limited and is, for example, rubber having a chemical resistance.

Functions of the first covering portion 132 and the second covering portion 142 are explained next as well as a flow of the chemical liquid.

In the first embodiment, as shown by the arrow A in FIG. 1, the chemical liquid flows downward in the pipe 1 vertically placed. At that time, the lower end portion of the first adhesion unit 151 is covered by the first covering portion 132 from the side of the hollow of the first joint member 13, that is, from the lower side in FIG. 1. Accordingly, the first adhesion unit 151 is not exposed to a fluid pressure of the chemical liquid. In this way, the first covering portion 132 can suppress a leakage of the chemical liquid from the first adhesion unit 151.

The upper end portion of the second adhesion unit 152 is covered by the second covering portion 142 from the side of the hollow of the second joint member 14, that is, from the upper side in FIG. 1. Accordingly, the second adhesion unit 152 is not exposed to the fluid pressure of the chemical liquid. This suppresses a leakage of the chemical liquid from the second adhesion unit 152.

Because the second covering portion 142 has the second inclined surface 142a formed on the inner circumferential surface 142A, the pipe resistance to the chemical liquid flowing downward is suppressed. This enables the chemical liquid to be flowed smoothly.

Such an operational effect of suppressing the pipe resistance can be achieved also in a case where the direction A of flowing the chemical liquid is reversed. In this case, the first inclined surface 132a formed on the first covering portion 132 suppresses the pipe resistance to the chemical liquid. In this way, the chemical liquid flowing in the opposite direction to that shown by the arrow A in FIG. 1 can be smoothly flowed.

The operational effect of suppressing the pipe resistance can be achieved also in a case where the pipe joint 10 is inverted upside down with respect to the configuration shown in FIG. 1. Also in this case, the first inclined surface 132a suppresses the pipe resistance to the chemical liquid. In this way, the chemical liquid flowing in the opposite direction to that shown by the arrow A in FIG. 1 can be smoothly flowed.

Furthermore, because the same operational effect can be achieved even when the pipe joint 10 is inverted upside down, a work of confirming the direction of the pipe joint 10 is not required during assembly of the pipe 1. Accordingly, the work efficiency can be enhanced and the labor can be reduced during assembly of the pipe 1.

As described above, with the pipe 1 according to the first embodiment, leakages of the chemical liquid passing through the pipe 1 from connection points of the pipe 1 to outside the pipe 1 can be suppressed.

### Second Embodiment

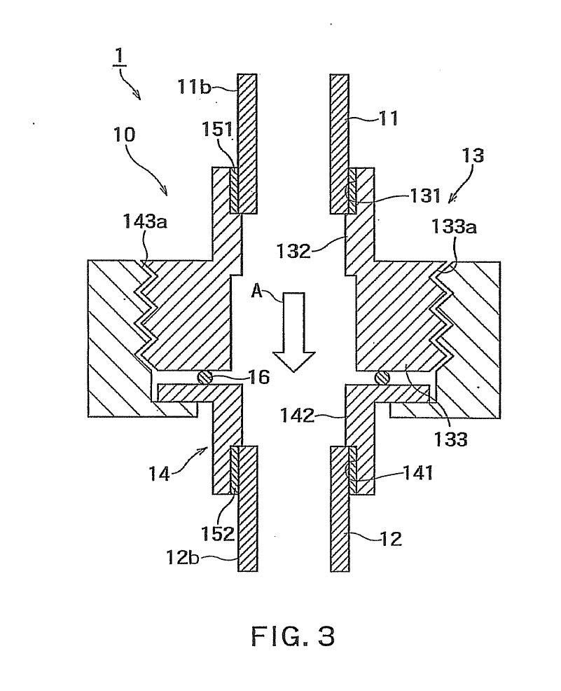

FIG. 3 is a cross-sectional view showing an example of a configuration of the pipe 1 according a second embodiment. In the second embodiment, the first covering portion 132 protrudes up to the position of the outer circumferential surface 11b of the first piping unit 11. The second covering portion 142 protrudes up to the position of the outer circumferential surface 12b of the second piping unit 12.

Other configurations of the second embodiment can be identical to corresponding ones of the first embodiment. Also in the second embodiment, the first and second covering portions 132 and 142 can suppress leakages of the chemical liquid from the first and second adhesion units 151 and 152.

### Third Embodiment

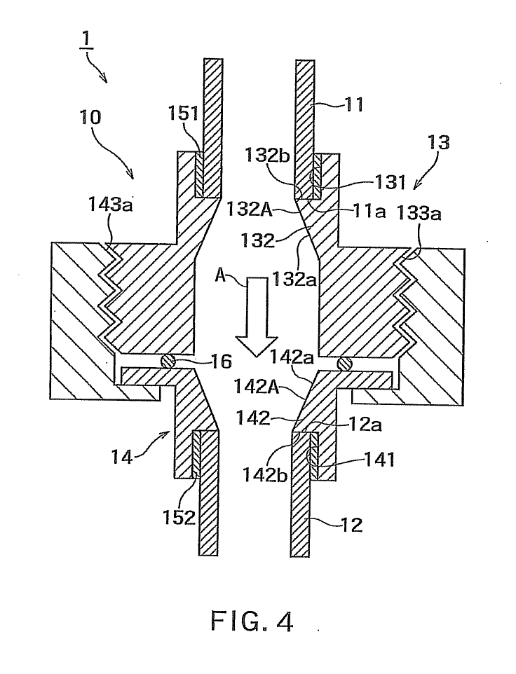

FIG. 4 is a cross-sectional view showing an example of a configuration of the pipe 1 according to a third embodiment. In the third embodiment, the first inclined surface 132a is formed all over the inner circumferential surface 132A of the first covering portion 132. The second inclined surface 142a is formed all over the inner circumferential surface 142A of the second covering portion 142.

Other configurations of the third embodiment can be identical to corresponding ones of the first embodiment. Also in the third embodiment, operational effects identical to those of the first embodiment can be achieved. Furthermore, because the hollow of the pipe joint 10 can be enlarged in the third embodiment, the pipe resistance can be reduced and the chemical liquid can be passed therethrough more smoothly.

The first to third embodiments can be combined as appropriate. In addition, it is also possible to provide any one of the first inclined surface 132a and the second inclined surface 142a located on a downstream side.

While certain embodiments have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

1. A piping component comprising:
a first joint member having a first piping unit inserted thereto and being bonded to the first piping unit; and
a second joint member being connected to the first joint member, having a second piping unit inserted to the second joint member, and being bonded to the second piping unit, wherein
the first joint member has a first covering portion covering one of end portions of a bonding unit between the first joint member and the first piping unit, located in an insertion direction of the first piping unit, from a side of a hollow of the first joint member, and
the second joint member has a second covering portion covering one of end portions of a bonding unit between the second joint member and the second piping unit, located in an insertion direction of the second piping unit, from a side of a hollow of the second joint member.

2. The piping component of claim 1, wherein
the first joint member has a first bonding surface surrounding an outer circumferential surface of the first piping unit and bonding to the first piping unit,
the second joint member has a second bonding surface surrounding an outer circumferential surface of the second piping unit and bonding to the second piping unit,
the first covering portion is formed at an end portion of the first bonding surface on a side in the insertion direction of the first piping unit all around the end portion and protrudes to inside the first joint member relative to the first bonding surface, and
the second covering portion is formed at an end portion of the second bonding surface on a side in the insertion direction of the second piping unit all around the end portion and protrudes to inside the second joint member relative to the second boding surface.

3. The piping component of claim 2, wherein the first covering portion has a first inclined surface inclining to an outer side of the first joint member toward the insertion direction of the first piping unit on an inner circumferential surface of the first covering portion.

4. The piping component of claim 3, wherein the first inclined surface is formed on the inner circumferential surface of the first covering portion all around the inner circumferential surface.

5. The piping component of claim 2, wherein the second covering portion has a second inclined surface inclining to an outer side of the second joint member toward the insertion direction of the second piping unit on an inner circumferential surface of the second covering portion.

6. The piping component of claim 5, wherein the second inclined surface is formed on the inner circumferential surface of the second covering portion all around the inner circumferential surface.

7. The piping component of claim 2, wherein
the first covering portion has a first inclined surface inclining to an outer side of the first joint member toward the insertion direction of the first piping unit on an inner circumferential surface of the first covering portion, and
the second covering portion has a second inclined surface inclining to an outer side of the second joint member toward the insertion direction of the second piping unit on an inner circumferential surface of the second covering portion.

8. The piping component of claim 7, wherein
the first inclined surface is formed on the inner circumferential surface of the first covering portion all around the inner circumferential surface, and
the second inclined surface is formed on the inner circumferential surface of the second covering portion all around the inner circumferential surface.

9. A pipe comprising:
a first piping unit;
a second piping unit;
a first joint member having the first piping unit inserted thereto and being bonded to the first piping unit; and
a second joint member being connected to the first joint member, having the second piping unit inserted to the second joint member, and being bonded to the second piping unit, wherein
the first joint member has a first covering portion covering one of end portions of a bonding unit between the first joint member and the first piping unit, located in an insertion direction of the first piping unit, from a side of a hollow of the first joint member, and
the second joint member has a second covering portion covering one of end portions of a bonding unit between the second joint member and the second piping unit, located in an insertion direction of the second piping unit, from a side of a hollow of the second joint member.

10. The pipe of claim 9, wherein
the first joint member has a first bonding surface surrounding an outer circumferential surface of the first piping unit and bonding to the first piping unit,
the second joint member has a second bonding surface surrounding an outer circumferential surface of the second piping unit and bonding to the second piping unit,
the first covering portion is formed at an end portion of the first bonding surface on a side in the insertion direction of the first piping unit all around the end portion and protrudes to inside the first joint member relative to the first bonding surface, and
the second covering portion is formed at an end portion of the second bonding surface on a side in the insertion direction of the second piping unit all around the end portion and protrudes to inside the second joint member relative to the second boding surface.

11. The pipe of claim 10, wherein the first covering portion protrudes at least on an end face of the first covering portion on a side of the first piping unit up to a position of the outer circumferential surface of the first piping unit or to an inner side than the outer circumferential surface of the first piping unit.

12. The pipe of claim 10, wherein the second covering portion protrudes at least on an end face of the second covering portion on a side of the second piping unit up to a position of the outer circumferential surface of the second piping unit or to an inner side than the outer circumferential surface of the second piping unit.

13. The pipe of claim 10, wherein
the first covering portion protrudes at least on an end face of the first covering portion on a side of the first piping unit up to a position of the outer circumferential surface of the first piping unit or to an inner side than the outer circumferential surface of the first piping unit, and
the second covering portion protrudes at least on an end face of the second covering portion on a side of the second piping unit up to a position of the outer circumferential surface of the second piping unit or to an inner side than the outer circumferential surface of the second piping unit.

14. The pipe of claim 11, wherein the first covering portion protrudes up to a position of the inner circumferential surface of the first piping unit or to an outer side than the inner circumferential surface of the first piping unit.

15. The pipe of claim 12, wherein the second covering portion protrudes up to a position of the inner circumferential surface of the second piping unit or to an outer side than the inner circumferential surface of the second piping unit.

16. The pipe of claim 13, wherein
the first covering portion protrudes up to a position of the inner circumferential surface of the first piping unit or to an outer side than the inner circumferential surface of the first piping unit, and
the second covering portion protrudes up to a position of the inner circumferential surface of the second piping unit or to an outer side than the inner circumferential surface of the second piping unit.

17. The pipe of claim 10, wherein
the first covering portion has a first inclined surface inclining to an outer side of the first joint member toward the insertion direction of the first piping unit on an inner circumferential surface of the first covering portion,
the second covering portion has a second inclined surface inclining to an outer side of the second joint member toward the insertion direction of the second piping unit on an inner circumferential surface of the second covering portion,
the first inclined surface is formed on the inner circumferential surface of the first covering portion all around the inner circumferential surface, and
the second inclined surface is formed on the inner circumferential surface of the second covering portion all around the inner circumferential surface.

18. The pipe of claim 9, wherein an end face of the first covering portion on a side of the first piping unit and an end face of the first piping unit on a side of the first covering portion are parallel to each other.

19. The pipe of claim 9, wherein an end face of the second covering portion on a side of the second piping unit and an end face of the second piping unit on a side of the second covering portion are parallel to each other.

20. The pipe of claim 9, wherein
an end face of the first covering portion on a side of the first piping unit and an end face of the first piping unit on a side of the first covering portion are parallel to each other, and
an end face of the second covering portion on a side of the second piping unit and an end face of the second piping unit on a side of the second covering portion are parallel to each other.
